(19) United States
(12) Patent Application Publication
(10) Pub. No.: US 2001/0006511 A1
(43) Pub. Date: Jul. 5, 2001

(54) Process for coordinated echo- and/or noise reduction

(76) Inventor: Hans Jurgen Matt, Remseck (DE)

Correspondence Address: SUGHRUE, MION, ZINN,, MACPEAK & SEAS, PLLC, 2100 Pennsylvania Avenue, N.W., Washington, DC, 20037-3213, US

(21) Appl. No.: 09/739,104

(22) Filed: Dec. 19, 2000

(30) Foreign Application Priority Data
Jan. 3, 2000 (DE) 100 00 009.6

(51) Int. Cl. H04L 1/00; H04J 1/16; H04L 12/26

(52) U.S. Cl. 370/286; 370/329; 370/252

(57) ABSTRACT

A method for echo and noise compensation in communication systems in which communication terminals are interconnected via switching facilities and transmission links and in which echo- and/or noise-compensating devices are provided in a subset of communication terminals and switching facilities comprises the steps of:

(a) defining a uniform measure of quality for the properties of the communications terminals in terms of their respective generation of echoes and/or noise signals, including any echo-compensation and/or echo-reduction capabilities;

(b) capturing the corresponding quality values of at least one communication terminal involved in a communications connection;

(c) determining additionally necessary measures to compensate the echo and/or noise signals to a predetermined residual value; and

(d) performing the determined measures using a compensator in at least one switching facility involved in the communications connection.

In this way, optimum adaptation of the compensating devices to the conditions of a transmission path for a communications connection in an arbitrary area of a complex communication network is achieved and the interaction of existing facilities is optimized at low cost.

The invention relates to a process for compensating and/or reducing echo- and/or noise signals in telecommunications (=TC) systems for the transmission of acoustic useful signals, in particular human speech, in TC networks in which TC terminals are interconnected via switching equipment and transmission links wherein, at least in a sub-quantity of TC terminals and/or at least in a sub-quantity of switching equipment, devices are provided for compensating and/or reducing echo- and/or noise signals. Such a process is known for example from DE 42 29 912 A1.

The term “switching equipment” in a process of the type referred to in the introduction is to be understood in this context as a generic term for all possible types of equipment participating in a TC connection, such as for example local switching centres, trunk switching centres, mobile switching centres, transmitting and receiving stations, radio relay devices, telecommunications satellites, call-centres, service-centres, concentrators, multiplex devices, front-end devices and the like, but not for TC terminals.

Echo- and noise suppression is continuously increasing in importance for speech quality in communications networks in which a telephone transmission is often affected by severe interference as a result of line echoes or acoustic echoes and as a result of background noises.

During a natural communication between humans, the amplitude of the spoken speech is normally automatically adapted to the acoustic environment. However in the case of a speech communication between remote locations, the conversation partners are not situated in the same acoustic environment and therefore are not aware of the acoustic situation at the location of the other conversation partner. Therefore a particularly serious problem occurs if one of the partners is compelled to speak very loudly due to his acoustic environment, whereas the other partner generates speech signals of low amplitude in a quiet acoustic environment.

In addition, the problem exists that an “electronically generated” noise also occurs on a TC channel and is co-transmitted as background to the useful signal. Furthermore, it is also advantageous to reduce or suppress interference signals such as undesired background noise (street noise, factory noise, office noise, canteen noise, flight noise etc). For improved telephone call comfort it is generally endeavoured to minimise all types of noise.

Finally so-called echoes also arise in TC connections, these occurring in the form of line echoes in all analogue TC terminals with a two-wire connection, in two-wire TC networks and basically at all junctions from two-wire operation to four-wire operation.

Additionally, acoustic echoes are produced for example in TC terminals due to a part of the loudspeaker signals being fed-back to the microphone.

Furthermore, speech-coded acoustic echoes occur in particular in central equipment (e.g. mobile switching centres=MSC) since the echo in the TC terminal is coded with a speech coder prior to transmission to the switching equipment (e.g. MSC) and is decoded again in the switching equipment.

Echo suppression devices for the three types of echoes can differ considerably since the characteristics of these echoes differ distinctly from one another.

Line echoes can have a long delay time as long propagation times can occur between the location at which they arise and the location at which they are compensated. Such propagation times are mainly due to satellite connections and sea cables, but also to transmission systems and terminals with complex transmission procedures (e.g. video telephony in ISDN with approx. 250 ms/direction; etc.). During a connection the line echoes generally remain stationary, i.e. the echo impulse response of the TC channel remains substantially unchanged.

In the case of acoustic echoes the signal propagation time is substantially shorter, but the echo impulse response of the room constantly changes, in particular upon movements of persons in the room.

In the case of speech-coded acoustic echoes a further complication consists in that it is no longer possible to measure the echo impulse response as there is no linear system and the waveform of the echo signals no longer corresponds to that of the transmitted signals, such as for example in the case of mobile radiocommunications; in addition a delay of approximately 100 ms/direction also occurs.

Therefore when a mixture of speech signals and interference signals are transmitted via TC networks it is generally important to reduce the amplitude of the interference signals, such as noise and echo, as far as possible. For this purpose, in the network nodes of the known TC networks a number of, in part entirely different, devices are used to compensate and/or reduce echo- and/or noise signals, said devices having properties which differ from one another and in part cause mutual interference between said devices.

A known process for noise reduction is that of so-called “spectral subtraction”. In the case of spectral subtraction, firstly the noise is measured in the speech pauses and continuously stored in a memory in the form of a power density spectrum. The power density spectrum is obtained via a Fourier transformation. Upon the occurrence of speech, the stored noise spectrum is then subtracted “as best current estimated value” from the current, disturbed speech spectrum, and then transformed back into the time domain in order thus to achieve a noise reduction for the disturbed signal. A disadvantage of spectral subtraction consists in that the process of fundamentally inaccurate spectral noise estimation followed by subtraction also gives rise to errors in the output signal manifesting as “musical tones”. Furthermore this known process is fundamentally unsuitable for the suppression of echo signals in TC connections.

Extended spectral signal processing, as described for example in the publication “A New Approach to Noise Reduction Based on Auditory Masking Effects” by S. Gustafsson and P. Jax, ITG Fachtagung, Dresden, 1998 is a spectral noise reduction process which takes into account an acoustic masking threshold (for example according to the MPEG standard). Firstly the power density spectra for the noise and the speech itself are estimated using spectral substraction. When these sub-spectra are known, a spectral acoustic masking threshold R_{T}(f) for the human ear is then calculated for example using MPEG-Standard rules. With the aid of this masking threshold and the estimated spectra for noise and speech, a filter transmission curve H(f) is then calculated in accordance with a simple rule, said curve being such that substantial spectral components of the speech are transmitted as far as possible unchanged and spectral components of the noise are as far as possible reduced. Then the original disturbed speech signal is fed only through this filter in order thus to obtain a noise reduction for the disturbed signal. The advantage of this process consists in that “nothing is added to or subtracted from” the disturbed signal and therefore estimation errors are less or hardly perceptible. A disadvantage of such processes consists in the outlay required to determine this acoustic masking threshold and the execution of all the computing operations associated with this process.

In the known compander process, such as described for example in DE 42 29 912 A1 referred to in the introduction, the degree of noise- and echo reduction is determined in accordance with a fixed transfer function. The compander firstly has the property of transmitting speech signals with a specific (pre-set) “normal speech signal level” (optionally referred to as normal loudness) virtually unchanged from its input to its output. If the input signal now becomes too loud however, for example because a speaker comes too close to his microphone, a dynamic compressor limits the output level to virtually the same value as in a normal situation in that the current amplification in the compander is linearly reduced with increasing input loudness. As a result of this property, the speech at the output of the compander system remains at approximately the same loudness level irrespective of the degree of fluctuation of the input loudness.

If on the other hand a signal with a level smaller than the normal level is now fed to the input of the compander, the signal is additionally attenuated in that the amplification is readjusted so that background noises are transmitted as far as possible only in attenuated form. The compander thus consists of a compressor for speech signal levels greater than or equal to a normal level and of an expander for signal levels smaller than the normal level. A disadvantage of the compander approach is that the compression of the speech signal level gives rise to a modulation which changes the speech signal in such a way that the result is often subjectively experienced as unsatisfactory.

With the increasing variety of TC terminals which are commercially available (classic POT, wired or cordless, analogue or digital telephones, mobile telephones etc.) and the large number of different digitalization processes for speech (PCM μ-law, PCM A-law, ADPCM, CELP-coders for mobile radiocommunications such as FR, HR, EFR, AMR, . . . ) the subject of “echo and noise compensation” is becoming ever more complex and is taking on a new dimension since the different processes and associated devices arrive at different results in different ways and can operate in part in the same direction but also in part in opposite directions. Due to the use of ever newer technologies for interference signal processing, new difficult questions relating to the overall result also constantly arise:

What gain or even loss of quality is attained by stepped, cascaded echo-and/or noise compensation in communications networks?

Can multiply serially connected echo- or noise compensators of the same or even different construction type mutually interfere with one another?

In the case of multiply serially connected echo- and/or noise compensators, should only one compensator per transmission path (outgoing and return direction) in each case be activated in the TC network?

In mobile radiocommunications should the interference signal compensation take place in the TC network or in the TC terminal?

What happens if a handsfree device is used for mobile radiocommunications in the car, while a conventional echo compensator is used in the corresponding TC connection in the network?

If a mobile terminal has good echo- and/or noise compensation, how can the following compensators be deactivated to avoid destructive indifferences?

If a mobile terminal of an older construction type has no acoustic echo compensation, how is it possible to recognise that an echo compensator is to be activated in the TC network?

Can measures for a possible quality improvement in a TC connection be distributed between different locations or units in the TC network and if so, how?

In the case of mobile operation, should the data received by a handset be transmitted to a remote handset (so-called tandem-free operation=TFO) or is it better, as previously, to recode the speech in accordance with PCM A-law in order then to be able to effect a better echo compensation?

Normally devices for echo compensation in TC networks contain an adaptive filter (=FIR) which attempts to simulate the echoes and to subtract them from the received signal, and/or a non-linear process (=NLP) with the aid of which residual echoes are to be eliminated. In modem operation, the ITU-T standards provide for example that the modem tone (2100 Hz) is recognised and that then any echo compensators or NLPs which may be present in the signal path are deactivated. Similar applies to the signalling tones according to the C5-standard, a predecessor of CCITT No. 7 signalling. These known recommendations do not however specify the procedure to be adopted in the above described cases of a complex combination of widely differing devices and processes.

In contrast, the object of the present invention is to propose a process comprising the measures described in the introduction wherein, in a manner which is as clear, uniform, effortless and cost-efficient as possible, devices provided for compensating and/or reducing echo- and/or noise signals can be adapted as optimally as possible to the actually existing conditions of a transmission path in a TC connection in an arbitrary area of a complex TC network and the cooperation between the provided devices can be optimised.

In accordance with the invention, this object is achieved in respect of the handling of echoes in a both simple and efficient manner by the following process steps:

(a) definition of a uniform quality gauge for the properties of the TC terminals in terms of their respective generation of echo signals including possibly provided capabilities of compensating and/or reducing echo signals;

(b) detection of the quality values, corresponding to the quality gauge according to step (a), of at least one TC terminal participating in a TC connection;

(c) determination of measures required in addition to an optionally already performed echo reduction for reducing the echo signals to a previously specified residual value taking into account the quality values detected in step (b);

(d) implementation of the determined measures by means of a device for compensating and/or reducing echo signals in at least one item of switching equipment participating in the TC connection.

In respect of the handling of noise, the object of the invention is achieved by the following steps:

(a′) definition of a uniform quality gauge for the properties of the TC terminals in terms of their respective emission of noise signals into the TC network including possibly provided capabilities of compensating and/or reducing noise signals;

(b′) detection of the quality values, corresponding to the quality gauge according to step (a′), of at least one TC terminal participating in a TC connection;

(c′) determination of measures required in addition to an optionally already performed noise reduction, for reducing the noise signals to a previously specified residual value taking into account the quality values detected in step (b);

(d′) implementation of the determined measures by means of a device for compensating and/or reducing noise signals in at least one item of switching equipment participating in the TC connection.

Due to the definition and determination of quality features in a TC connection via a communications network, the central equipment in the network can be set so as to facilitate optimal echo compensation and/or noise reduction. Here the rule applies that only as much signal processing as is currently necessary is to be used in order to keep the speech signals as natural as possible in an interference-free situation.

The quality features of a TC connection can be determined in diverse ways, as will be explained in detail in the following:

On the one hand the terminals can be pre-classified into quality categories. Then each terminal can signal its quality category to the network. In particular it can be signalled whether line echoes, acoustic echoes or speech-coded echoes are concerned, i.e. whether the TC terminal is a two-wire device or an ISDN telephone or a mobile telephone. The equipment can then be set so as to facilitate an optimal echo compensation/reduction.

Another method of determining quality features can consist of measuring the quality of the received signals in a device, e..g of a lower item of switching equipment in the network hierarchy, for example the residual echo of said signals, the magnitude of which may be impermissibly large, or also the noise level in the signal. A combination of signalling and measurement is also possible.

An optimal echo compensation/reduction always relates to the echo value instantaneously determined for the relevant TC connection, the echo type and the desired residual value of the echo which is oriented in particular to the signal propagation time of the TC connection in the network. Long signal propagation times require a smaller residual value, whereas short signal propagation times permit a larger residual value.

The setting of the optionally distributed devices in the TC network takes place in such manner that the in each case nearest device reduces the echoes and noises emanating from the near end to a predetermined residual value and then communicates this reduction to the devices higher up in the network hierarchy. If this takes place independently in both directions, a high quality TC connection is achieved. It is immaterial whether an echo- and/or noise reduction- and/or compensation device is present in the lowest network level or in a higher network level. The device nearest to the relevant location of the transmitted signals is preferentially in each case set at the particular optimal value for echo suppression or for the handling of interference signals.

A particularly preferred variant of the process according to the invention is that in which the quality values, corresponding to the quality gauge according to step (a) and (a′), for the characteristics of signals emanating from one or more TC terminals and/or items of switching equipment, are detected in at least one, in each case superordinate, item of switching equipment.

A preferred further development is that in which the quality values of TC terminals and of devices, participating in the TC connection, which serve to compensate and/or reduce echo- and/or noise signals and are present in switching equipment used at a subordinate location in the TC network hierarchy, are in each case detected by a superordinate item of switching equipment.

Since a TC terminal and a TC network operator are initially unaware of which echo- and/or noise reduction- and/or compensation devices are used where overall in the TC network, and since the best possible function of the device is to be achieved so that as far as possible there is no mutual interference between the devices, it is advantageous if each item of equipment in the network

a) primarily “looks” in a preferred direction, preferably towards the near TC subscriber;

b) on the basis of signallings of a lower item of equipment or of a terminal and/or on the basis of its own measurements, recognises the echo types or noises concerned;

c) performs a calculation accordingly;

d) then sets its own echo- and noise reduction- and/or compensation device such that the signals are suitably processed as required or that the signals pass through unchanged so as to retain their quality as far as possible.

It is also preferable for the measures according to step (c) and (c′) to be determined with cooperation between the devices used in the participating switching equipment and to be performed in at least one device of said switching equipment. The coordination between the devices at different locations in the TC network is to prevent unfavourable mutual influence between the devices during the signal processing, e.g. in that both systems process the same signal direction and thereby change the disturbed speech too greatly.

In a variant of the process according to the invention already referred to in the foregoing, the quality values in step (b) and (b′) are at least partially detected by measuring the signals emitted by the corresponding TC terminals. Measurement of the signal qualities is advantageous when old TC terminals or old equipment, which do not recognise signalling and/or mutual coordination between the equipment, participate in the TC connection. In such cases each new item of equipment preferably looks in the direction of the near subscriber and measures the qualities of the received signals.

Another particularly preferred process variant is that in which the quality values in step (b) are detected at least in part by active signalling thereof from the corresponding TC terminals to their respective superordinate switching equipment upon the establishment of the TC connection. Active signalling has the advantage that a TC terminal and/or a lower item of equipment can provide an item of equipment higher in the network hierarchy with more accurate information as to the prevailing signal qualities and as to the signal processing measures which have already been performed or have not yet been performed.

A further variant of the process according to the invention provides that, once detected, quality values of TC terminals are stored in an item of switching equipment, preferably in the item of switching equipment directly superordinate to the relevant TC terminal and/or in a central storage device in the TC network.

A further improvement consists in that the quality values in step (b) are detected at least in part by reading out the corresponding, stored data.

For a TC connection, advantageously the quality gauges of the signals and the possibly implemented signal processing measures are stored in a memory of the device or the switching unit so that all the other devices in the TC network or TC connection can have optional access thereto in order that

a) mutual negative influence between the echo- and/or noise reduction- and/or compensation devices can be avoided

b) an optimal setting of all the devices in the TC connection can be facilitated

c) a central analysis of the signal qualities in the network section can be facilitated thus permitting the early detection of failings in network sections.

A particularly preferred variant of the process according to the invention is that in which the quality values of the quality gauge according to step (a) and (a′) are classified in n quality categories. Classification into quality categories (e.g. of the TC terminals, of the equipment) facilitates

a) simpler calculation in the superordinate equipment in respect of the signal processing to be performed, e.g. by reading the setpoint values in tables

b) optional simpler signalling between the equipment

c) optional abandonment of costly measurement of the signal qualities in each superordinate device.

Classification into residual echo categories according to decibel (=dB) values currently corresponds to the general agreement that residual echoes be measured in dB. The specifications of the standardization organisations (ITU-T) contain formulae for calculating the setpoint values of a residual echo in dB.

Classification in accordance with other properties of echo reduction devices, for example classification into convergence time ranges is effective, particularly in accordance with the current regulations of the standardization organisations (ITU-T).

In another variant of the process according to the invention, the additionally required measures in step (c) and (c′) can be determined by calculation from the quality values detected in step (b) and (b′), preferably in one of the items of switching equipment participating in the TC connection or in a central processor in the TC network. Calculation of the required additional attenuation of echoes has the advantage that in this way only the essentially required degree of signal processing is performed in order to keep the disturbed speech as natural as possible.

An alternative variant of the process according to the invention is characterised in that the additionally required measures in step (c) and (c′) are determined on the basis of the quality values detected in step (b) and (b′) in that said measures are read from a storage device, which is connected to the TC network and which stores a matrix of the measures to be implemented in the case of specific constellations of switching equipment participating in a TC connection and quality values of the TC terminals, preferably by one of the items of switching equipment participating in the TC connection or by a central processor in the TC network. Reading the additionally required measures and their intensity from stored tables has the advantage that the computation power of the processors participating in the device is wholly available for the real time signal processing which in some cases is highly complex.

Another advantageous variant of the process according to the invention provides that the quality gauge defined in step (a) takes into account the echo coupling TCL_{w} (=Terminal Coupling Loss, weighted) of the corresponding TC terminal. If the echo coupling of a TC terminal is known, then the optionally required additional echo attenuation can be calculated very easily on the basis of the determined signal propagation time in the TC channel.

It is also advantageous for the quality gauge defined in step (a) and (a′) to take into account the convergence time of a device for compensating and/or reducing echo- and/or noise signals of the corresponding TC terminal. If compensators of different manufacturers requiring different convergence times operate in the TC network, it can be advantageous to take this behaviour into account in a more modern device, for example to avoid erroneous measurements at the start of a connection.

In another advantageous process variant, the quality gauge defined in step (a) and (a′) takes into account the magnitude of the residual echo in double-talk operation between the participating TC terminals. The setting of echo- and/or noise reduction devices is particularly difficult upon the occurrence of double talk when both speakers speak simultaneously. The magnitude of the residual echo in this operating mode is also a gauge of the quality of the activated echo reduction devices.

Advantageously, the maximum signal propagation time in the TC connection is also specified and taken into account in the determination of the measures in step (c) and (c′). In this way, as already mentioned in the foregoing, optionally required additional echo attenuation measures can be calculated particularly simply.

A particularly preferred variant of the process according to the invention is that in which speech-pause detection is used to determine when a speech signal or a speech pause is present in the mixture of useful signals and interference signals to be transmitted. A device for detecting speech pauses offers the advantage that the noise can be reduced particularly simply, for example by means of an expander, in speech pauses.

A good noise level estimation requires a good speech-pause detector as only then can one be certain that the speech pause sections contain only disturbing noise and not some mixture of noise and shreds of speech, as frequently happens in practice.

Advantageously, an aurally correct noise reduction can be linked with an independently operating echo reduction. This is particularly important when virtually no background noise exists in the telephone channel as then no noise reduction is operative and therefore occurring echoes can reach the speaker unhindered.

It is expedient to separate the control of a noise reduction from that of an echo reduction as noises and echoes occur independently of one another and also generally have entirely different physical origins. However a general mathematical reduction function R can be given describing a reduction in signal levels both for noises and also for echoes:

R(S, N ES, τ_{E}, ERL, thrs)˜g(S/N).d(ES, τ_{E}, ERL, thrs)

wherein g(S/N) is a noise reduction dependent upon the current signal-to-noise ratio S/N and d( . . . ) is the additional, independently occurring echo reduction when the estimated echo signal exceeds the given threshold value thrs.

A process variant in which an artificial noise signal is additionally added to the useful signal for the duration of an echo reduction is particularly advantageous.

A noise reduction is constant at a uniform noise level. An additional, suddenly occurring echo reduction in the rhythm of the speech also signifies a noise reduction (at least in the short time section) in the speech rhythm. This leads to a pulsed background noise which does not sound natural. Therefore it is advantageous, at the moments of an additional echo reduction, to add to the processed signal a synthetic noise of a suitable noise generator in the order of magnitude of the normal background noise. In this way as uniform as possible a background noise is to be provided for the hearer.

If artificial noise is added to a signal, this is helpful

a) in the case of completely undisturbed transmission to possibly avoid the impression of a line interruption during the speech pauses;

b) to mask weak points in the signal processing (e.g. short muting in the case of echoes) by means of a quiet noise.

The noise generator can be designed such that the artificial noise signal comprises an acoustic signal sequence found to be psychoacoustically pleasant (=comfort noise). A suitable artificial noise consists of noise signals which are as similar as possible to the natural noise in the channel.

In place of a synthetic background noise it is also possible however for a section of a previously recorded genuine background noise of suitable strength to be inserted into the echo time sections. The added noise is then virtually no different to the previous noise and therefore will not make a disturbing acoustic impression on the listener.

The addition of noises for the acoustic masking of effects and the measures for separate handling of noises and echoes, when correctly adapted to one another, will produce a particulary clear and pleasant speech impression even in the case of a “difficult” environment (echoes plus noises).

A variant of the process according to the invention in which the useful signal to be transmitted undergoes spectral subtraction is particularly preferred. The advantage of spectral subtraction followed by level reduction in the speech pauses is that firstly a part of the interference noises is eliminated from the speech signal itself by spectral subtraction and only then are the speech pauses freed of noises and echoes in the described manner. In subjective tests this combination results in better overall auditory impressions than spectral subtraction alone.

Another particularly advantageous variant of the process according to the invention provides that the useful signal to be transmitted is subjected to spectral filtering adapted to the human ear. Here again noises, speech and echoes are firstly estimated using the spectral subtraction means, whereupon an aurally correct masking threshold is defined and then the entire signal is processed via a suitably set transmission filter so that the speech components are as far as possible unadulterated and the echo- and noise components are as far as possible substantially suppressed.

A combination with the following level reduction in the speech pauses further improves the auditory impression.

Finally, centre-clippers, dynamically controlled expanders, speech-pause-controlled expanders and/or companders can also be used in the devices for compensating and/or reducing echo- and/or noise signals.

Each of these procedures has specific advantages and disadvantages. By suitably combining the procedures, the optimisation can be shifted towards best speech quality or for example minimal computation power depending upon requirements.

The scope of the present invention also includes a server unit, a processor assembly and a gate-array assembly for supporting the above described process according to the invention and a computer program for executing the process. The process can be implemented both as a hardware circuit and also in the form of a computer program. Software programming for high-power DSPs is currently preferred as new insights and additional functions can more easily be implemented by changing the software on an existing hardware basis. However, processes can also be implemented as hardware modules, for example in TC terminals or telephone equipment.

Further advantages of the invention will become apparent from the description and the drawing. Equally, the above mentioned features and those yet to be described can be used in accordance with the invention either individually or jointly in any desired combinations. The illustrated and described embodiments should not be considered as conclusive but rather as examples for the description of the invention.

The invention is illustrated in the drawing and will be explained in detail in the form of exemplary embodiments.

In the drawing:

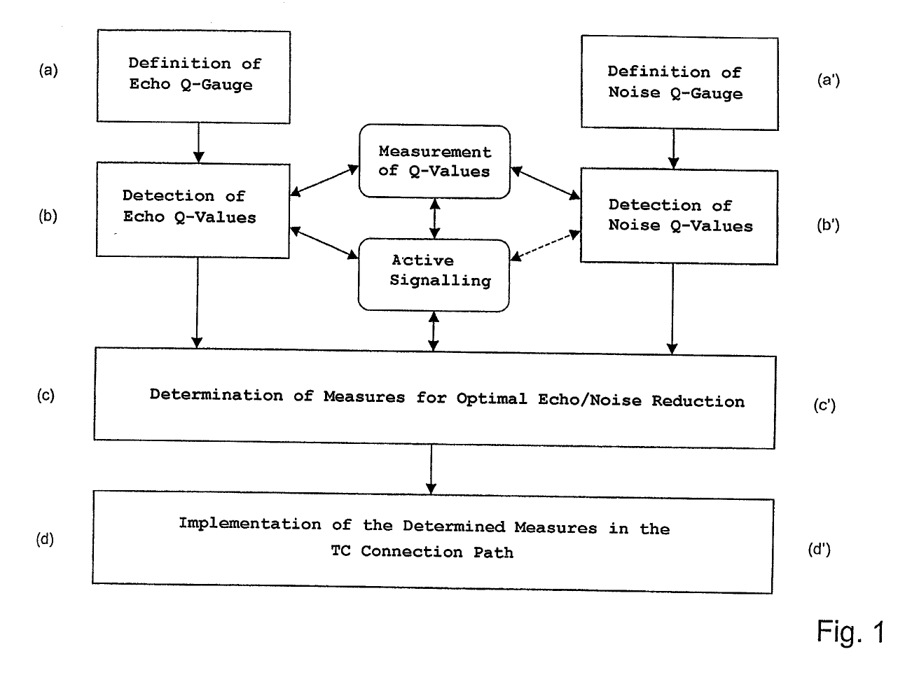

FIG. 1 is a schematic flow diagram of the process according to the invention for handling echoes and noise, and

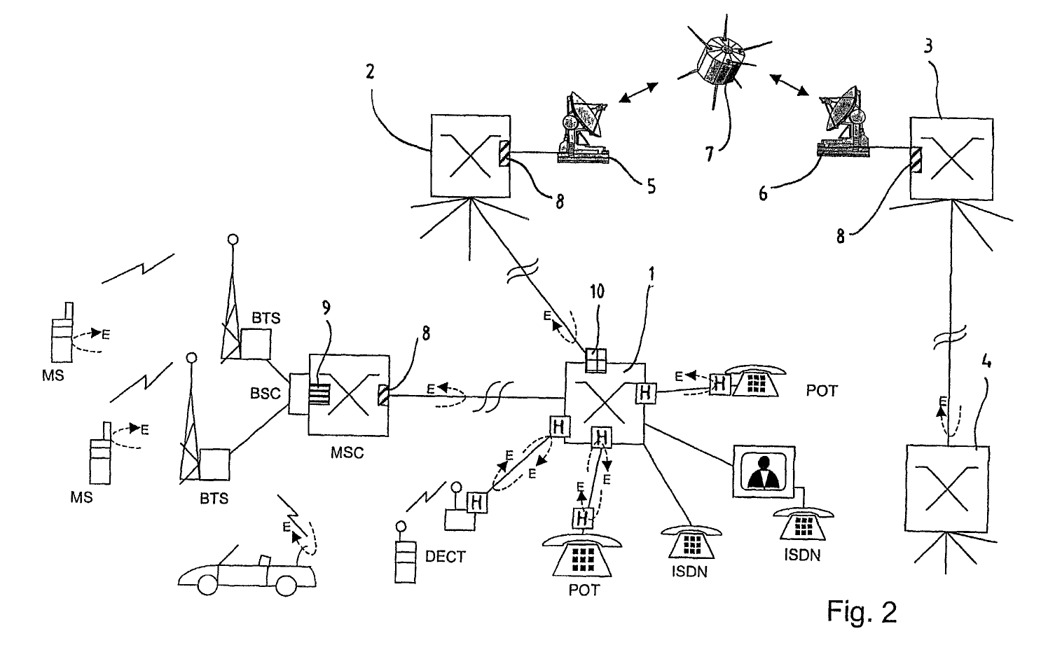

FIG. 2 is a schematic diagram of the different connection paths in a modern TC network.

In the flow diagram shown in FIG. 1, the process steps for handling both echoes and noise according to the process according to the invention have been jointly shown. As opposed to detecting the quality values in terms of the noise signals, which can take place exclusively by measurement, alternatively or additionally the echo quality values can be detected by active signalling from the TC terminals. From the detected quality values, measures are then determined for optimally adapting the equipment to the connection path actually to be handled in terms of the best possible echo- and/or noise reduction, and are coordinated with one another by signalling between the equipment in the TC path.

In the last step, the determined measures are then implemented in the participating equipment.

In the portion shown in FIG. 2 of a complex situation in a modern TC network, mobile telephones (MS), cordless telephones (DECT), analogue telephones of an old type (POT), digital telephones (ISDN) and video telephones have been illustrated as TC terminals. A local switching centre 1, trunk switching centres 2, 3, 4, a mobile switching centre (MSC) with a control unit (BSC) for transmitting and receiving stations, transmitting and receiving stations for mobile radiocommunications (BTS), satellite radiocommunications systems 5, 6 and a telecommunications satellite 7 have been shown as switching equipment. A part of the switching equipment contains a compensator 8 for line echoes and noise reduction. The mobile switching centre MSC also contains a compensator 9 for speech-coded acoustic echoes of TC terminals which operate with speech coding, where the compensator 9 can also effect a noise reduction. Finally the local switching centre 1 also contains a compensator 10 for acoustic echoes of terminals and line echoes without speech coding and possibly having noise reduction capabilities.

Possible echo reflections at so-called hybrids H, i.e. hybrid circuits for two-wire-four-wire conversion have been indicated by broken-line arrows and referenced E.

In the case of the confusingly complex situation illustrated in FIG. 2 which typically occurs in modern telecommunications networks and in which the degree of complexity is constantly increased by new technical innovations, the handling of echoes and/or noise can be clearly and simply adapted to the concrete connection situation, and thus optimised, with the aid of the process according to the invention.

1. A process for compensating or reducing echo signals in telecommunications (=TC) systems for the transmission of acoustic useful signals, in particular human speech, in TC networks in which TC terminals (POT, DECT, ISDN, MS) are interconnected via switching equipment (1, 2, 3, 4, 5, 6, 7, MSC, BSC, BTS) and transmission links, wherein at least in a sub-quantity of TC terminals or at least in a sub-quantity of switching equipment (1, 2, 3, MSC) devices (8, 9, 10) for compensating or reducing echo signals are provided,
characterised by the following steps:
(a) definition of a uniform quality gauge for the properties of the TC terminals (POT, DECT, ISDN, MS) in terms of their respective generation of echo signals including possibly provided echo signal compensation- or reduction capabilities;
(b) detection of the quality values, corresponding to the quality gauge according to step (a), of at least one TC terminal (POCT, DECT, ISDN, MS) participating in a TC connection;
(c) determination of measures, required in addition to an optionally already performed echo reduction, for reducing the echo signals to a previously specified residual value taking into account the quality values detected in step (b);
(d) implementation of the determined measures by means of a device (8, 9, 10) for compensating or reducing echo signals in at least one item of switching equipment (1, 2, 3, MSC) participating in the TC connection.

2. A process for compensating or reducing noise signals in telecommunications (=TC) systems for the transmission of acoustic useful signals, in particular human speech, in TC networks in which TC terminals (POT, DECT, ISDN, MS) are interconnected via switching equipment (1, 2, 3, 4, 5, 6, 7, MSC, BSC, BTS) and transmission links, wherein at least in a sub-quantity of TC terminals or at least in a sub-quantity of switching equipment (1, 2, 3, MSC) devices (8, 9, 10) for compensating or reducing noise signals are provided,
characterised by the following steps:
(a′) definition of a uniform quality gauge for the properties of the TC terminals (POT, DECT, ISDN, MS) in terms of their respective emission of noise signals into the TC network including possibly provided noise signal compensation- or reduction capabilities;
(b′) detection of the quality values, corresponding to the quality gauge according to step (a′), of at least one TC terminal (POT, DECT, ISDN, MS) participating in a TC connection;
(c′) determination of measures required in addition to an optionally already performed noise reduction for reducing the noise signals to a previously specified residual value taking into account the quality values detected in step (b′);
(d′) implementation of the determined measures by means of a device (8, 9, 10) for compensating or reducing noise signals in at least one item of switching equipment (1, 2, 3, MSC) participating in the TC connection.

3. A process according to claim 1, characterised in that the quality values, corresponding to the quality gauge according to step (a) and (a′), for the properties of one or more TC terminals (POT, DECT, ISDN, MS) are detected in at least one, in each case superordinate, item of switching equipment (1, 2, 3, 4, 5, 6, 7, MSC, BSC, BTS) and that the quality values of TC terminals (POT, DECT, ISDN, MS) and the quality values of devices (8, 9, 10), participating in the TC connection, which serve to compensate or reduce echo- or noise signals and are present in switching equipment (1, 2, 3, MSC) used at a subordinate location in the TC network hierarchy, are in each case detected by a superordinate item of switching equipment.

4. A process according to claim 3, characterised in that the measures according to step (c) and (c′) are determined with cooperation between the devices (8, 9, 10) used in the participating switching equipment (1, 2, 3, MSC) and are implemented in at least one device (8, 9, 10) of said switching equipment (1, 2, 3, MSC).

5. A process according to claim 2, characterised in that the quality values, corresponding to the quality gauge according to step (a) and (a′), for the properties of one or more TC terminals (POT, DECT, ISDN, MS) are detected in at least one, in each case superordinate, item of switching equipment (1, 2, 3, 4, 5, 6, 7, MSC, BSC, BTS), and that the quality values of TC terminals (POT, DECT, ISDN, MS) and the quality values of devices (8, 9, 10), participating in the TC connection, which serve to compensate or reduce echo- or noise signals and are present in switching equipment (1, 2, 3, MSC) used at a subordinate location of the TC network hierarchy, are in each case detected by a superordinate item of switching equipment.

6. A process according to claim 5, characterised in that the measures according to step (c) and (c′) are determined with cooperation between the devices (8, 9, 10) used in the participating switching equipment (1, 2, 3, MSC) and are implemented in at least one device (8, 9, 10) of said switching equipment (1, 2, 3, MSC).

7. A process according to claim 1, characterised in that the quality values in step (b) and (b′) are detected at least in part by measuring the signals emitted by the corresponding TC terminals (POT, DECT, ISDN, MS).

8. A process according to claim 2, characterised in that the quality values in step (b) and (b′) are detected at least in part by measuring the signals emitted by the corresponding TC terminals (POT, DECT, ISDN, MS).

9. A process according to claim 1, characterised in that the quality values in step (b) and (b′) are detected at least in part by active signalling thereof from the corresponding TC terminals (POT, DECT, ISDN, MS) to their respective superordinate switching equipment (1, MSC) upon the establishment of the TC connection.

10. A process according to claim 2, characterised in that the quality values in step (b) and (b′) are detected at least in part by active signalling thereof from the corresponding TC terminals (POT, DECT, ISDN, MS) to their respective superordinate switching equipment (1, MSC) upon the establishment of the TC connection.

11. A process according to claim 1, characterised in that, once detected, quality values of TC terminals (POT, DECT, ISDN, MS) are stored in an item of switching equipment (1, 2, 3, 4, 5, 6, 7, MSC, BSC, BTS), preferably in the item of switching equipment (1, MSC) directly superordinate to the respective TC terminal (POT, DECT, ISDN, MS) and/or in a central storage device in the TC network, and that the quality values in step (b) and (b′) are detected at least in part by reading the corresponding stored data.

12. A process according to claim 2, characterised in that, once detected, quality values of TC terminals (POT, DECT, ISDN, MS) are stored in an item of switching equipment (1, 2, 3, 4, 5, 6, 7, MSC, BSC, BTS), preferably in the item of switching equipment (1, MSC) directly superordinate to the respective TC terminal (POT, DECT, ISDN, MS) and/or in a central storage device in the TC network, and that the quality values in step (b) and (b′) are detected at least in part by reading the corresponding stored data.

13. A process according to claim 1, characterised in that the quality values of the quality gauge according to step (a) and (a′) are classified in n quality categories.

14. A process according to claim 2, characterised in that the quality values of the quality gauge according to step (a) and (a′) are classified in n quality categories.

15. A process according to claim 1, characterised in that the additionally required measures in step (c) and (c′) are determined by calculation from the quality values detected in step (b) and (b′), preferably in one of the items of switching equipment (1, 2, 3, 4, 5, 6, 7, MSC, BSC, BTS) participating in the TC connection or in a central processor in the TC network.

16. A process according to claim 2, characterised in that the additionally required measures in step (c) and (c′) are determined by calculation from the quality values detected in step (b) and (b′), preferably in one of the items of switching equipment (1, 2, 3, 4, 5, 6, 7, MSC, BSC, BTS) participating in the TC connection or in a central processor in the TC network.

17. A process according to claim 1, characterised in that the additionally required measures in step (c) and (c′) are determined on the basis of the quality values detected in step (b) and (b′) in that said measures are read from a storage device, which is connected to the TC network and stores a matrix of the measures to be implemented in the case of specific constellations of switching equipment (1, 2, 3, 4, 5, 6, 7, MSC, BSC, BTS) participating in a TC connection and quality values of the TC terminals (POT, DECT, ISDN, MS), preferably by one of the items of switching equipment (1, 2, 3, 4, 5, 6, 7, MSC, BSC, BTS) participating in the TC connection or by a central processor in the TC network.

18. A process according to claim 2, characterised in that the additionally required measures in step (c) and (c′) are determined on the basis of the quality values detected in step (b) and (b′) in that said measures are read from a storage device, which is connected to the TC network and stores a matrix of the measures to be implemented in the case of specific constellations of switching equipment (1, 2, 3, 4, 5, 6, 7, MSC, BSC, BTS) participating in a TC connection and quality values of the TC terminals (POT, DECT, ISDN, MS), preferably by one of the items of switching equipment (1, 2, 3, 4, 5, 6, 7, MSC, BSC, BTS) participating in the TC connection or by a central processor in the TC network.
